(19) United States
(12) Patent Application Publication
(10) Pub. No.: US 2004/0132579 A1
(43) Pub. Date: Jul. 8, 2004

(54) Roller bearing and method of making the same

(75) Inventors: Noriko Uchiyama, Kanagawa (JP); Yoshiteru Yasuda, Yokohama (JP); Takeshi Yamamoto, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/623,158

(22) Filed: Jul. 21, 2003

(30) Foreign Application Priority Data
Aug. 28, 2002 (JP) 2002-248121
Dec. 6, 2002 (JP) 2002-355367

(51) Int. Cl. F16H 15/38

(52) U.S. Cl. 476/46

(57) ABSTRACT

A roller bearing is provided which comprises a pair of bearing rings at least one of which has an annular rib, and a plurality of rollers interposed between the bearing rings. Each of the rollers has a roller end face in sliding contact with the rib. A residual austenite structure in at least one of the rib and the roller end face is 20 to 60 vol. %. A method of producing a roller bearing and a toroidal CVT using such a bearing are also provided.

### BACKGROUND OF THE INVENTION

The present invention relates to a roller bearing including cylindrical rollers, tapered rollers or barrel shaped rollers, particularly of the kind having an improved resistance to seizure due to exhaustion or lack of lubricating oil and suitable for use in a toroidal CVT (Continuously Variable Transmission). The present invention further relates to a method of making such a roller bearing and a toroidal CVT having the same.

Generally, in a roller bearing having a pair of bearing rings (inner and outer rings) and a plurality of rollers interposed between the bearing rings, one of the bearing rings has a rib in sliding contact with a roller end face of each of the rollers, which sliding contact accompanies a large slippage. Thus, if the amount of lubricating oil supplied to the bearing is small or lubricating oil is exhausted, seizure may possibly be caused at the joint between the rib and the roller end face.

For example, a differential gearing disclosed in Japanese Unexamined Patent Publication No. 5-185858 is disposed within a housing that is attached to a vehicle body by means of stud bolts. The differential gearing includes a ring gear, differential case, pinion mate shaft, differential pinions and side gears. The differential case is rotatably supported on the housing by means of tapered roller bearings. In such a tapered roller bearing, seizure may possibly be caused at the joint between the rib and the roller end face due to the fact that when the lubricating oil stored in the differential casing, when subjected to a centrifugal force, may possibly be held at a limited portion within the differential casing for thereby causing a condition similar to that in which the lubricating oil has been exhausted or due to the fact that the temperature of the bearing may become so high at rapid acceleration.

A toroidal CVT includes a pair of input and output disks formed into a toroidal shape and power rollers interposed therebetween. The toroidal CVT is capable of varying a gear ratio continuously by varying the inclination of the power rollers. In such a toroidal CVT, a tapered roller bearing is used for supporting inner and outer rings of each power roller while being held within traction oil. In such a tapered roller bearing, there occurred such a phenomenon of the friction coefficient becoming so high due to exhaustion or lack of lubricating oil.

FIG. 1 shows an example of a shifting mechanism in a toroidal CVT. In the toroidal CVT, a driving power from an engine is inputted to input shaft 1 by way of a torque converter and a forward and backward movement switching mechanism. Coaxially with input shaft 1 is disposed torque transmission shaft 2. To the opposite ends of torque transmission shaft 2 are splined so as to be movable axially thereof first input disk 3 and second input disk 4. Between the back surface of first input disk 3 and input shaft 1 is interposed loading cam mechanism 5 that generates an axial thrust force in accordance with an input torque. Further, between the back surface of second input disk 4 and nut 6 threadedly engaged with an end portion of torque transmission shaft 2 is interposed Belleville washer 7 that applied a preload to both input disks 3, 4.

At a middle position between both input disks 3, 4 is disposed output disk 8 that is freely rotatably installed on torque transmission shaft 2. Output disk 8 is made up of two output disk portions that are joined together to constitute an integral unit and has an outer peripheral portion formed with output gear 9. The output disk 8 side facing surface of first input disk 3, the output disk 8 side facing surface of second input disk 4 and the input disk 3, 4 side facing surfaces of output disk 8 are formed with toroidal grooves 3a, 4a, 8a, 8b, respectively.

Between the toroidal grooves 3a, 8a are disposed two upper and lower first power rollers 10, 10 so as to be capable of transmitting a power therebetween by means of an oil film shearing force. Similarly, between toroidal grooves 4a, 8b are disposed two upper and lower second power rollers 11, 11 so as to be capable of transmitting a power therebetween by means of an oil film shearing force. By first input disk 3, output disk 8 and first power rollers 10, 10 is constituted first toroidal gearshift portion 12. By second input disk 4, output disk 8 and second power roller 11, 11 is constituted second toroidal gearshift portion 13.

In the toroidal CVT structured as above, power rollers 10, 10, 11, 11 are inclined so as to attain an inclination angle corresponding to a gear ratio by an operation that will be described later, vary the input rotation of both input disks 3, 4 continuously and transmit it to output disk 8.

FIG. 2A is a cross sectional view of power roller 10 (the same as power roller 11) used in the above-described toroidal CVT. Power roller 10 includes inner race (bearing ring) 30 that transmits a power of first input disk 3 to output disk 8 by means of a shearing force of an oil film, outer race (bearing ring) 31 that is supported swingably or slidably on a trunnion (not shown) and tapered roller bearing 32 that supports outer race 31 rotatably on inner race 30.

Tapered roller bearing 32 includes raceway surface 30a formed in inner race 30, raceway surface 31b formed in outer race 31, tapered rollers 32c, roller end faces 32f in contact with annular rib 31d that guides tapered rollers 32c, and cage 32e (refer to FIG. 2B) that holds a plurality of tapered rollers 32c. In the meantime, there is not provided a radial bearing for supporting a radial load that acts upon inner race 30 but such a load is entirely supported by tapered roller bearings 32.

Hereinbefore, in order to prevent seizure at the joint between rib 31d of outer race 31 and roller end face 32d of each tapered roller 32c, it is known a method of making the surface roughness of the joining end faces of rib 31d and roller 32c larger for thereby eliminating metal-to-metal contact as much as possible or as disclosed in Japanese Unexamined Patent Publication No. 2001-187916, a method of forming a nitride layer on the surface of high Cr steel for thereby suppressing a rise of friction coefficient.

### SUMMARY OF THE INVENTION

However, in case a roller bearing used in transmission oil or gear oil added with a relatively large amount of additives such as zinc dithiophosphates (ZDTPs), corrosion wear occurs more than adhesion wear so that the a large anti-seizure effect is attained by making larger the surface roughness. In contrast to this, in case a bearing is used in traction oil added with a relatively small amount of additives, adhesion wear occurs more than corrosion wear and metal-to-metal contact at the joint between the rib and the roller end face occurs each time an operation speed is varied between high and low repeatedly. Thus, there arises a problem that the joining end faces of the rib and each roller are inevitably roughened and seizure is likely to be caused at the joint between the rib and the roller end face.

Further, as disclosed in Japanese Unexamined Patent Publication No. 2001-187916, formation of a nitride layer on high Cr steel not only requires the material to be changed but encounters a problem that it is difficult to form a stable nitride layer but an oxidized Cr layer is liable to be formed when a nitriding process is performed in an usual atmosphere. Heretofore, roller bearings have the above-noted problems to be solved.

It is accordingly an object of the present invention to provide a roller bearing that can attain a sufficient anti-seizure property even when lubricating oil is exhausted and therefore can attain a long life, without requiring a change in material or particular heat treatment.

It is a further object of the present invention to provide a method of making a roller bearing of the above-described character.

It is a further object of the present invention to provide a toroidal CVT having a roller bearing of the above-described character.

To achieve the above-described objects, there is provided according to an aspect of the present invention a roller bearing comprising a pair of bearing rings at least one of which has an annular rib, and a plurality of rollers interposed between the bearing rings, each of the rollers having a roller end face in sliding contact with the rib, wherein a residual austenite structure in at least one of the rib and the roller end face is 20 to 60 vol. %.

According to another aspect of the present invention, there is provided a method of producing a roller bearing including a pair of bearing rings at least one of which has an annular rib, and a plurality of rollers interposed between the bearing rings, each of the rollers having a roller end face in sliding contact with the rib, the method comprising subjecting at least one of a set of the bearing rings and a set of the rollers to carbonitriding and tempering so that a residual austenite structure in at least one of the rib and the roller end face is 20 to 60 vol. %.

### BRIEF DESCRIPTION OF THE DRAWINGS

FIG. 1 is a schematic view of a shifting mechanism of a toroidal CVT in which a roller bearing according to the present invention is incorporated;

FIG. 2A is a sectional view of a power roller used in the shifting mechanism of FIG. 1; and

FIG. 2B is a plan view of a cage of the power roller of FIG. 2A.

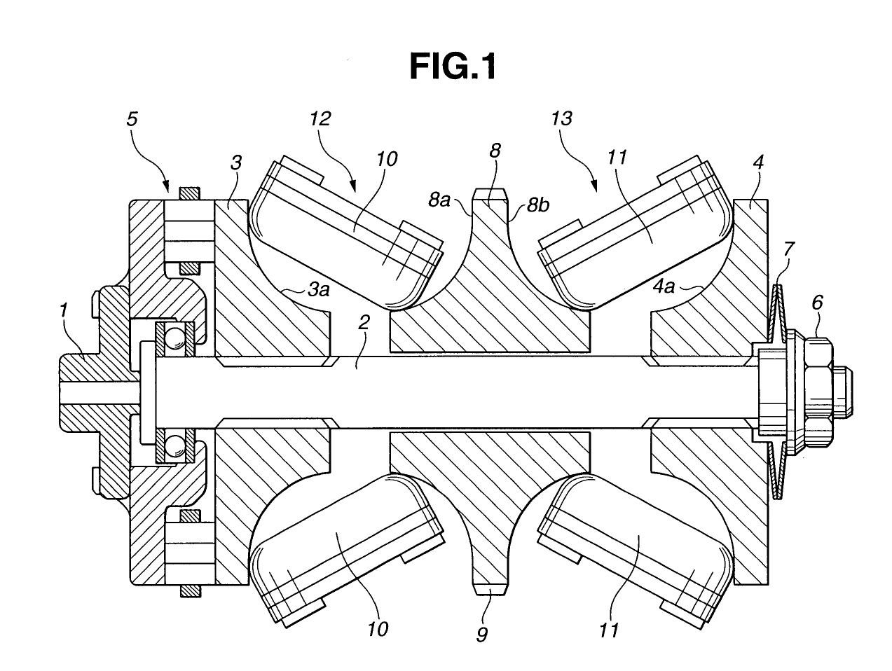

### DESCRIPTION OF THE PREFERRED EMBODIMENT

In a roller bearing according to the present invention, a large amount of residual austenite structure is formed in one of or both of a rib of a bearing ring and an end face of each of rollers for contact with the rib. Further, the hardness of one of or both of the rib of the bearing ring and the end face of each of the rollers for contact with the rib is made lower than that of one of or both of the raceway surface of the bearing ring and the rolling contact surface of each of the rollers. Further, the surface roughness of one of or both of the rib of the bearing ring and the roller end face of each roller for contact with the rib is made equal to or lower than 0.03 μm Ra. By this, when the rib and the roller end face are brought into metal-to-metal contact, the residual austenite structure serves as a cushion or buffer member for producing an effect of mitigating the stress. Further, when the supply amount of lubricating oil is decreased due to the fitting of the joining surfaces after running-in or exhaustion of lubricating oil, a sufficient anti-seizure property at the joint between the rib and the roller end face can be attained. Further, since the raceway surface and the rolling contact surface have a high hardness and therefore a good rolling fatigue strength, the roller bearing can attain an elongated life.

Further, such a roller bearing can be obtained by subjecting at least one of a set of the bearing rings and a set of the rollers to carbonitriding and tempering so that the amount of residual austenite structure at the surface thereof is within the range from 20 to 60 vol. % or by further subjecting, after the carbonitriding and tempering, at least one of the raceway surface of each of the bearing rings and the rolling contact surface of each of the rollers to after treatment so that the amount of residual austenite structure is less than 20 vol. %.

The after treatment to which the rolling contact surface is subjected can be attained by, for example, hard turning or roller burnishing. By this, the raceway surface and/or rolling contact surface is partially and plastically deformed so as to become flattened and have a surface roughness suitable to a bearing, and the residual austenite is transformed into martensite by stress induced transformation, thus making higher the surface hardness.

Further, after the rolling contact surface is subjected to shot peening or shot brast for causing the compressive residual stress and thereby making higher the surface hardness, the surface roughened by the shot peening or brast can be finished by grinding to a suitable surface roughness, so that the rolling fatigue life can be elongated.

The roller bearing of this invention is suitable for use in the toroidal CVT since it can prevent the seizure at the joint between the rib of the bearing ring and the roller end face of each roller that are used in traction oil as described above and has a sufficiently long life.

The present invention will be described further in detail based on examples.

### EXAMPLE 1

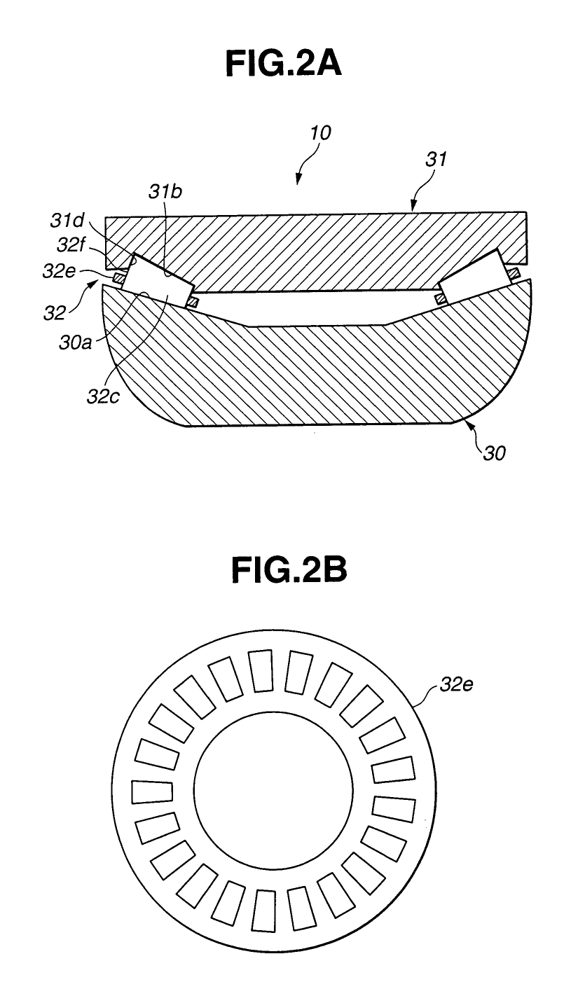

From SUJ2, i.e., a high carbon chromium bearing steel prescribed in JIS G4805, similar inner and outer bearing rings or races to those shown in FIG. 2A were formed, then subjected to carbonitriding treatment (i.e. carbonitriding at 850° C. for four hours and quenching in the oil of 60° C.) and tempering (at 160° C. for two hours), and then finished by grinding to the surface roughness of 0.03 μm Ra. Similarly, similar rollers to those shown in FIG. 2A were formed from SUJ2, then subjected to refining (i.e., heating at 850° C. for one hour and quenching in the oil of 60° C.), and finished by grinding to the surface roughness of about 0.03 μm Ra.

### EXAMPLE 2

From SCM435, i.e., a Chromium Molybdenum steel prescribed in JIS G4105, similar inner and outer bearing rings were formed, then subjected to carbonitriding treatment (i.e., carbonitriding at 850° C. for eight hours and quenching in the oil of 60° C.) and tempering (at 160° C. for two hours), and then finished by grinding to the surface roughness of 0.01 μm Ra. On the other hand, similar rollers were formed from SUJ2, then subjected to refining (i.e., heating at 850° C. for one hour and quenching in the oil of 60° C.) and finished by grinding to the surface roughness of about 0.0 μm Ra.

### EXAMPLE 3

Similar inner and outer rings and rollers were formed from SUJ2, then subjected to carbonitriding process (i.e., carbonitriding at 850° C. for four hours and then quenching in the oil of 60° C.), and finished by grinding to the surface roughness of about 0.0 μm Ra.

### EXAMPLE 4

Similar inner and outer bearing rings were formed from SUJ2 and subjected to carbonitriding (i.e., carbonitriding at 850° C. for four hours and then quenching in the oil of 60° C.) and tempering (at 160° C. for two hours). Then, only the raceway surfaces of the bearing rings were subjected to shot blast, and the bearing rings were finished by grinding to the surface roughness 0.01 μm Ra. In the meantime, the shot blast was performed under the condition where an air nozzle type blast machine with an air nozzle of the diameter of 5 mm was used and steel beads of #300 were used at the injection pressure of 0.5 Mpa, for the injection time of 80 seconds and at the injection distance of 120 mm.

On the other hand, similar rollers were formed from SUJ2, then subjected to refining (i.e., heating at 850° C. for one hour and quenching in the oil of 60° C.), and finished by grinding to the surface roughness of about 0.01 μm Ra.

### EXAMPLE 5

Similar inner and outer bearing rings were formed from SCM435, then subjected to carbonitriding treatment (i.e., carbonitriding at 850° C. for eight hours and then quenching in the oil of 60° C.) and tempering (at 160° C. for two hours). Then, only the raceway surfaces of the bearing rings were subjected to shot blast, and the bearing rings were finished by grinding to the surface roughness 0.01 μm Ra. On the other hand, similar rollers were formed from SUJ2, then subjected to refining (i.e., heating at 850° C. for one hour and then quenching in the oil of 60° C.) and finished by grinding to the surface roughness of about 0.01 μm Ra.

### EXAMPLE 6

Similar inner and outer bearing rings were formed from SCM435, then subjected to carbonitriding treatment (i.e., carbonitriding at 850° C. for eight hours and then quenching in the oil of 60° C.) and tempering (at 160° C. for two hours). Then, only the raceway surfaces of the inner and outer bearing rings were processed by hard turning so as to have the surface roughness of 0.01 μm Ra. In the meantime, the hard turning was performed by using an indexable insert made of CBN (Cubic Boron Nitride) and having the shape of 80° diamond and the nose radius of 0.8 mm as a cutting tool and under the condition of the cutting speed of 250 mm/min., the feed speed of 0.05 mm/rev. and the depth of cut of 0.05 mm.

On the other hand, similar rollers were formed from SUJ2, subjected to refining (i.e., heating at 85° C. for one hour and then quenching in the oil of 60° C.) and finished by grinding to the surface roughness of about 0.01 μm Ra.

### EXAMPLE 7

Similar inner and outer bearing rings were formed from SCM435 and subjected to carbonitriding treatment (i.e., carbonitriding at 850° C. for eight hours and thereafter quenching in the oil of 60° C.) and tempering (at 160° C. for two hours). Then, only the raceway surfaces of the bearing rings were subjected to shot peening and finished by grinding to the surface roughness of about 0.0 μm Ra. In the meantime, the shot peening was performed by using an air nozzle type shot peening machine and round cut wires of the average particle size of 0.3 to 0.4 mm in diameter and of the hardness of 700 to 800 Hv as shots (balls) and under the condition of the arc height of 0.48 mmA and coverage of 300% or more.

On the other hand, similar rollers were formed from SUJ2 and subjected to refining (i.e., heating at 850° C. for one hour and thereafter quenching in the oil of 60° C.) and finished by grinding to the surface roughness of about 0.01 μm Ra.

### EXAMPLE 8

Similar inner and outer bearing rings and rollers were formed SUJ2 and subjected to carbonitriding treatment (i.e., carbonitriding at 850° C. for four hours and then quenching in the oil of 60° C.) and tempering (at 160° C. for two hours). Then, only the raceway surfaces of the bearing rings were subjected to shot blast similar to that described above and thereafter finished by grinding to the surface roughness of about 0.0 μm Ra.

### EXAMPLE 9

Similar inner and outer bearing rings were formed from SUJ2, then subjected to refining (i.e., heating at 850° C. for one hour and then quenching in the oil of 60° C.) and finished by grinding to the surface roughness of 0.01 μm Ra.

On the other hand, similar rollers were formed from SUJ2 and subjected to carbonitriding treatment (i.e., carbonitriding at 850° C. for four hours and then quenching in the oil of 60° C.) and tempering (at 160° C. for two hours). Then, only the raceway surfaces of the bearing rings were subjected to shot blast under the condition similar to that described with respect to EXAMPLE 4 and finished by grinding to the surface roughness of 0.01 m Ra.

### EXAMPLE 10

Similar inner and outer bearing rings were formed from SCM435 and subjected to carbonitriding treatment (i.e., carbonitriding at 850° C. for eight hours and then quenching in the oil of 60° C.) and tempering (at 160° C. for two hours). Then, only the raceway surfaces of the bearing rings were subjected to roller burnishing and thereby finished to the surface roughness of about 0.01 μm Ra. The roller burnishing was performed by using a ceramic roller of 6 mm in diameter and under the condition of the feed speed of 0.15 mm/rev., the work circumferential speed of 150 mm/min., and the pushing surface pressure of 6.0 Gpa.

On the other hand, similar rollers were formed from SUJ2, then subjected to refining (i.e., heating at 850° C. for one hour and then quenching in the oil of 60° C.) and finished by grinding to the surface roughness of about 0.0 μm Ra.

### EXAMPLE 11

Similar inner and outer bearing rings were formed from SUJ2, then subjected to carbonitriding treatment (i.e., carbonitriding at 850° C. for eight hours and then quenching in the oil of 60° C.) and tempering (at 160° C. for two hours) and finished by grinding to the surface roughness of about 0.04 μm Ra.

### COMPARATIVE EXAMPLE 1

Similar inner and outer bearing rings were formed from SUJ2, then subjected to refining (i.e., heating at 850° C. for one hour and then quenching in the oil of 60° C.) and finished by grinding to the surface roughness of about 0.04 μm Ra.

### COMPARATIVE EXAMPLE 2

Similar inner and outer bearing rings were formed from SUJ2, then subjected to refining (i.e., heating at 850° C. for one hour and then quenching in the oil of 60° C.) and finished by grinding to the surface roughness of about 0.01 μm Ra.

Measurement of the hardness and the amount of residual austenite at the surface was made with respect to the above-described examples of this invention and comparative examples and the result is shown in TABLE 1 together with the specifications (material and producing condition) of the inner and outer bearing rings and rollers of the examples of this invention and the comparative examples.

Each of the roller bearings thus obtained was subjected to a tapered roller bearing test under the condition shown in TABLE 2 to evaluate the anti-seizure property. Further, another tapered roller bearing test was performed under the condition shown in TABLE 3 to investigate the cumulative stress cycles until the separation or peeling of the rollers or the inner and outer bearing rings occurs and plot the result of investigation on a Weibull probability paper, thereby determining the damage probability 50% life (L50).

The test result is shown in TABLE 4.

TABLE 1

| | | | | | | | | Roller | | | | | | |
|---|---|---|---|---|---|---|---|---|---|---|---|---|---|---|
| | Inner and outer rings | | | | | | | | | Working | | | Residual γ | |
| Ex- | | | Working | | | Residual γ | | | | process of | Hardness (Hv) | | amount (%) | |
| am- | Kind | | process of | Hardness (Hv) | | amount (%) | | Kind | | rolling | | Rolling | | Rolling |
| ple | of | Heat | raceway | | raceway | | raceway | of | Heat | contact | End | contact | End | contact |
| No. | steel | treatment | surface | Rib | surface | Rib | surface | steel | treatment | surface | face | surface | face | surface |
| In- | | | | | | | | | | | | | | |
| ven- | | | | | | | | | | | | | | |
| tion | | | | | | | | | | | | | | |
| 1 | SUJ2 | Carbonitriding | No | 631 | 638 | 35 | 32 | SUJ2 | Refining | No | 722 | 720 | 11 | 12 |
| 2 | SCM435 | Carbonitriding | No | 708 | 712 | 23 | 20 | SUJ2 | Refining | No | 719 | 725 | 12 | 10 |
| 3 | SUJ2 | Carbonitriding | No | 632 | 636 | 34 | 30 | SUJ2 | Carbonitriding | No | 624 | 619 | 31 | 32 |
| 4 | SUJ2 | Carbonitriding | Shot | 625 | 785 | 38 | 18 | SUJ2 | Refining | No | 723 | 732 | 12 | 14 |
| | | | blasting | | | | | | | | | | | |
| 5 | SCM435 | Carbonitriding | Shot | 725 | 794 | 20 | 10 | SUJ2 | Refining | No | 719 | 722 | 16 | 14 |
| | | | blasting | | | | | | | | | | | |
| 6 | SCM435 | Carbonitriding | Hard | 720 | 851 | 23 | 7 | SUJ2 | Refining | No | 715 | 720 | 15 | 13 |
| | | | turning | | | | | | | | | | | |
| 7 | SCM435 | Carbonitriding | Shot | 718 | 841 | 21 | 8 | SUJ2 | Refining | No | 725 | 718 | 16 | 15 |
| | | | peening | | | | | | | | | | | |
| 8 | SUJ2 | Carbonitriding | Shot | 625 | 775 | 38 | 19 | SUJ2 | Carbonitriding | Shot | 628 | 782 | 38 | 18 |
| | | | blasting | | | | | | | blasting | | | | |
| 9 | SUJ2 | Refining | No | 720 | 720 | 15 | 15 | SUJ2 | Carbonitriding | Shot | 625 | 790 | 39 | 19 |
| | | | | | | | | | | blasting | | | | |
| 10 | SCM435 | Carbonitriding | Roller | 723 | 858 | 20 | 11 | SUJ2 | Refining | No | 718 | 725 | 16 | 13 |
| | | | burnishing | | | | | | | | | | | |
| 11 | SUJ2 | Carbonitriding | No | 630 | 625 | 35 | 37 | SUJ2 | Refining | No | 728 | 720 | 12 | 14 |
| Com- | | | | | | | | | | | | | | |
| para- | | | | | | | | | | | | | | |
| tive | | | | | | | | | | | | | | |
| ex- | | | | | | | | | | | | | | |
| am- | | | | | | | | | | | | | | |
| ple | | | | | | | | | | | | | | |
| 1 | SUJ2 | Refining | No | 733 | 727 | 14 | 17 | SUJ2 | Refining | No | 715 | 720 | 15 | 14 |
| 2 | SUJ2 | Refining | No | 715 | 718 | 15 | 16 | SUJ2 | Refining | No | 712 | 718 | 17 | 13 |

TABLE 2

| Load | 1200 | kN |
|---|---|---|
| Rotation speed | 6000 | rpm |
| Lube oil | Traction oil | |
| Supply amount of lube | 0.5 | L/min |
| oil before supply of | | |
| lube oil is stopped | | |
| Oil temperature | 80° | C. |

TABLE 3

| Load | 60 | kN |
|---|---|---|
| Rotation speed | 6000 | rpm |
| Lube oil | Traction oil | |
| Supply amount | 5 | L/min |
| of lube oil | | |
| Oil temperature | 120° | C. |

TABLE 4

| | Anti- | |
|---|---|---|
| | seizure | |
| Example No. | property* | L50 life* |
| Invention | | |
| 1 | 4.3 | 2.5 |
| 2 | 8.5 | 3.7 |
| 3 | 8.5 | 1.7 |
| 4 | 8.6 | 4.8 |
| 5 | 10.2 | 5.2 |
| 6 | 7.9 | 5.8 |
| 7 | 8.1 | 6.2 |
| 8 | 11.3 | 6.5 |
| 9 | 8.8 | 5.1 |
| 10 | 9.2 | 6.1 |
| 11 | 8.0 | 5.2 |
| Comparative | | |
| example | | |
| 1 | 1 | 1 |
| 2 | 3.1 | 2.9 |

*The anti-seizure property and L50 life is indicated by the time ratio relative to COMPARATIVE EXAMPLE 1.

As will be apparent from the result shown in TABLE 4, it was confirmed that the roller bearing of this invention had an excellent anti-seizure property at the joint between the rib and the roller end face and therefore a long life.

Namely, in case of the EXAMPLES 1 to 7, 10 and 11, and the residual γ amount of the roller end face is smaller than 20 vol. % and in contrast the amount of residual γ of the rib is in the range from 20 to 60 vol. %. Thus, even if skew occurs due to lack of lubricating, the stress at the joint between the rib and the roller end face is mitigated or lessened, thus improving the anti-seizure property. Further, by treatment applied to the raceway surface after carbonitriding, the residual γ structure in the raceway surface is transformed into martensite structure by strain induced transformation, so that the amount of residual γ becomes less than 20 vol. % and the hardness becomes so high, thus making it possible to attain an improved rolling fatigue strength.

Further, in case of a combination of the amount of residual γ of the rib and the roller end face being more than 20 vol. % and the surface roughness being 0.01 μm Ra, an ability of alleviating the stress caused when a skew occurs in the roller bearing due to lack of lubrication is large and therefore an increase of frictional heat is small, thus making it possible to improve the anti-seizure property considerably. Further, when the residual γ structure of the raceway surface is less than 20 vol. % and the surface roughness is set about 0.01 μm Ra, the rolling fatigue strength is improved considerably (EXAMPLE 8).

In case the residual γ structure of the roller end face is equal to or larger than 20 vol. % and the surface roughness is about 0.01 μm Ra, an improved anti-seizure property is obtained even when the residual γ structure is smaller than 20 vol. % since an increase of frictional heat can be small by the stress mitigation. Further, when the residual γ structure of the raceway surface of the inner ring is less than 20 vol. %, the residual γ structure of the rolling contact surface of the rollers the residual is less than 20 vol. % since partly transformed into martensite structure by shot blast, and the surface roughness of the rolling contact surface is set about 0.01 μm Ra, the rolling fatigue strength is improved (EXAMPLE 9).

In contrast to the above-described examples of this invention, when the surface roughness (Ra) of the rib and roller end face is relatively large, i.e., 0.04 μm Ra and the residual γ structure of the same is smaller than 20 vol. %, a large amount of heat is generated upon occurrence of skew due to lack of lubrication and seizure is caused in an early time (COMPARATIVE EXAMPLE 1).

Further, in case the residual γ structure of the rib and roller end face is smaller than 20 vol. % and the surface roughness is about 0.01 μm Ra, the rolling fatigue strength is improved to some extent but the anti-seizure property is not satisfactory (COMPARATIVE EXAMPLE 2).

Further, even in case, as the EXAMPLE 3 of this invention, the residual γ structure of both of the rib and roller end face is equal to or larger than 20 vol. %, the hardness of the raceway surface of a high surface pressure is small and the rolling fatigue life is not improved considerably though the anti-seizure property at the joint between the rib and roller end face is improved by the effect of stress mitigation.

In the meantime, in case the residual γ structure both of the rib and roller end face exceeds 60 vol. %, the hardness becomes low and the transmission efficiency is deteriorated so that such a rib and roller end face are not desirable.

The entire contents of Japanese Patent Applications P2002-248121(filed Aug. 28, 2002) and P2002-355367 (filed Dec. 6, 2002) are incorporated herein by reference.

Although the invention has been described above by reference to a certain embodiment of the invention, the invention is not limited to the embodiment described above. Modifications and variations of the embodiment described above will occur to those skilled in the art, in light of the above teachings. For example, while in the above-described embodiments shot blast, hard turning, shot peening and roller burnishing have been described as the after treatment of the raceway surface, the after treatment is not limited to them but any method can be used so long as it can cause the residual austenite structure to be changed into the martensite structure by stress induced transformation and it only causes a relatively small increase in the roughness of the treated surface. The scope of the invention is defined with reference to the following claims.

What is claimed is:

1. A roller bearing comprising:
a pair of bearing rings at least one of which has an annular rib; and
a plurality of rollers interposed between the bearing rings;
each of the rollers having a roller end face in sliding contact with the rib;
wherein a residual austenite structure in at least one of the rib and the roller end face is 20 to 60 vol. %.

2. A roller bearing according to claim 1, wherein at least one of the rib and the roller end face is smaller in hardness than at least one of a raceway surface of each of the bearing rings and a rolling contact surface of each of the rollers.

3. A roller bearing according to claim 2, wherein a residual austenite structure of at least one of the raceway surface and the rolling contact surface is less than 20 vol. %.

4. A roller bearing according to claim 1, wherein a surface roughness of each of the rib, the roller end face, the raceway surface and the rolling contact surface is equal to or smaller than 0.03 μm Ra.

5. A roller bearing according to claim 1, being used in traction oil.

6. A method of producing a roller bearing including a pair of bearing rings at least one of which has an annular rib, and a plurality of rollers interposed between the bearing rings, each of the rollers having a roller end face in sliding contact with the rib, the method comprising:
subjecting at least one of a set of the bearing rings and a set of the rollers to carbonitriding and tempering so that a residual austenite structure in at least one of the rib and the roller end face is 20 to 60 vol. %.

7. A method according to claim 6, further comprising:
after the carbonitriding and tempering, subjecting at least one of the raceway surface and the rolling contact surface to after treatment so that a residual austenite structure of at least one of the raceway surface and the rolling contact surface is less than 20 vol. %.

8. A method according to claim 7, wherein the subjecting at least one of the raceway surface and the rolling contact surface to after treatment comprises subjecting at least one of the raceway surface and the rolling contact surface to one of hard turning and roller burnishing.

9. A method according to claim 7, wherein the subjecting at least one of the raceway surface and the rolling contact surface to after treatment comprises:
subjecting at least one of the raceway surface and the rolling contact surface to one of shot peening and shot brast; and
after one of the shot peening and shot brast, finishing at least one of the raceway surface and the rolling contact surface by grinding.

10. A toroidal CVT comprising a roller bearing including a pair of bearing rings at least one of which has an annular rib, and a plurality of rollers interposed between the bearing rings, each of the rollers having a roller end face in sliding contact with the rib, wherein a residual austenite structure in at least one of the rib and the roller end face is 20 to 60 vol. %.

11. A toroidal CVT according to claim 10, wherein at least one of the rib and the roller end face is smaller in hardness than at least one of a raceway surface of each of the bearing rings and a rolling contact surface of each of the rollers.

12. A toroidal CVT according to claim 11, wherein a residual austenite structure of at least one of the raceway surface and the rolling contact surface is less than 20 vol. %.

13. A toroidal CVT according to claim 10, wherein a surface roughness of each of the rib, the roller end face, the raceway surface and the rolling contact surface is equal to or smaller than 0.03 μm Ra.
